(19) United States
(12) Patent Application Publication
(10) Pub. No.: US 2001/0047375 A1
(43) Pub. Date: Nov. 29, 2001

(54) Method for selecting multiple hyperlinks

(76) Inventor: Marcus Fest, Miami Beach, FL (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 09/829,152

(22) Filed: Apr. 9, 2001

Related U.S. Application Data
(63) Continuation-in-part of application No. 09/353,100, filed on Jul. 14, 1999.

(51) Int. Cl. G06F 15/00

(52) U.S. Cl. 707/526

(57) ABSTRACT

A user selectable method of selecting and displaying multiple web pages associated with uniform resource locators embedded in hyperlinks in a web page is provided wherein a user may choose to modify the standard means by which web pages associated with embedded uniform resource locators are displayed. Upon activating the modified method for displaying web pages associated with hyperlinks, the uniform resource locators embedded within hyperlinks are added to a list of uniform resource locators maintained in a computer's memory and, upon activation, the web page associated with each uniform resource locator in the list is retrieved and displayed as a panel in a single, continuous, scrollable web page having multiple panels.

This application is a continuation-in-part of U.S. patent application Ser. No. 09/353,100, filed Jul. 14, 1999, entitled “User-Controllable Presentation of Multiple Web Pages in One Single, Continuously Scrollable Display.” The present invention provides a user-controlled system to change the functionality of hyperlinks contained on a Web page to allow the collection of multiple links and the subsequent display of all information associated with the collected links inside a single, continuously scrollable Web page.

### BACKGROUND OF THE INVENTION

Applicant's earlier invention is a method for allowing a user to supply a list of uniform resource locators (URLs) pointing to hypertext markup language (HTML) files which are to be displayed as a “masterpage” inside a single browser window. The URL list is sent to a “masterpage engine” that collects and parses each page before combining it into the masterpage. The present invention relates to the characteristics of hyperlinks on a Web page and to the processes triggered by clicking on those hyperlinks or of changing the standard behavior of hyperlinks. More specifically, this invention allows a user to select multiple hyperlinks by clicking on them to create a URL list in the computer's memory that can then be sent to the masterpage engine and displayed as a single masterpage.

### DESCRIPTION OF RELATED ART

Hyperlinks are especially marked textual or graphical components on a Web page having the characteristic that each hyperlink has a Web address (also known as a URL) encoded within it. When the component is clicked on with a pointing device such as a mouse, the hyperlink causes a Web browser to display the Web page associated with the hyperlink's encoded URL, either by replacing the currently displayed Web page or by creating a new browser window for the display. Textual hyperlinks are usually underlined and colored blue; however, this is a convention only. The defining element of a hyperlink is the underlying HTML code that is used to turn normal text or a graphic into a hyperlink. A hyperlink's HTML code has the format: <a href=“url”> normal text or graphic </a> (with “url” standing for the Web address of the Web page to be displayed when the hyperlink is clicked on.

Web pages may contain many hyperlinks (as, for instance, on a newspaper's Web page where the article headlines may work as hyperlinks that display the associated article texts when clicked on). The prior art process of viewing (also called “following”) a Web page containing many hyperlinks is a time-consuming one, requiring the viewer to go back and forth from the page containing the links to each individual link, and including multiple waits while each linked page loads.

The standard process for viewing multiple Web pages requires the viewer to take following steps: Click on hyperlink; download associated Web page from the Web server (either inside current or inside new, additional browser window); view the Web page; click the browser's “Back” button (if the linked Web page opened inside the current browser window) or close browser window (if new additional browser window was opened) to return to page with the original hyperlink; and repeat the sequence to view next hyperlink. The process becomes especially inefficient if the page loading time and the navigational cursor movement takes longer or almost as long as viewing the hyperlinked Web pages themselves (as is the case with small Web pages, for instance on message boards Web sites or retail Web sites).

The 09/353,100 patent application, of which this is a continuation-in-part, describes one method for displaying multiple Web pages inside a singe, continuously scrollable Web page called a “masterpage”. A list of URLs selected by a viewer is processed such that all Web pages associated with the URLs are displayed inside a single masterpage. Specifically, the process provides a Web-based input interface (called a “form field box”) into which users manually enter URLs that they wish to view as a “masterpage.” When entry is complete, a URL list is created in a computer's memory and is passed on to the masterpage engine, which obtains each specified Web page and presents it as a single, scrollable masterpage. However, even though much of the back-and-forth activity associated with standard viewing of multiple links is alleviated in the prior application, there is still an inefficiency in a viewer's having to manually enter in a list each URL that he or she wishes to view. In addition, there is the associated problem of typographical errors that may crop up in manually typing URLs, many of which may lack punctuation or may use unusual punctuation.

Accordingly, there is a need for a method that will allow all selected links to be gathered merely by clicking on them, and to be displayed as a single, continually scrollable page. Such a method will eliminate much time that is presently wasted in viewing each hyperlinked page individually, and will reduce or eliminate the incidence of errors caused by a user's having to manually type each URL that he or she wishes to view.

### SUMMARY OF THE INVENTION

The operating environment for the present invention encompasses general distributed computing systems wherein any computer, using any one of a variety of operating systems, is connected to a Web server via a communication link. This invention provides a method of specifying URLs and creating a URL list simply by clicking upon hyperlinks the user wishes to view. Once created, the URL list is built and passed to the masterpage engine for download, parsing, and display as a masterpage, as is described in the pending application. According to this invention, the functionality of hyperlinks in a Web page is modified to provide a method of building of a URL list by clicking on multiple links. Clicking on a link does not open the associated Web page, which is the standard behavior of hyperlinks, but instead adds the associated URL to a URL list which can then be passed on to the masterpage engine for display as a masterpage. This process of navigating many links on a Web page saves time by replacing the tedious back-and-forth style of the standard navigational method with the much more convenient viewing of a single masterpage that contains all of the combined information associated with multiple links.

In accordance with the present invention, the problem of collecting the URLs of multiple hyperlinks into a URL list and then displaying said URLs as a masterpage has been addressed by modifying the HTML code of the Web page containing the links such that the set of actions normally triggered by clicking on said links is modified to cause the URL to be listed in a URL list. The HTML code of the Web page containing the links is further modified so that the Web page will display additional control elements (links or buttons) that allow the user to change the hyperlinks' behavior and to build a URL list to be passed to the masterpage engine for display of a masterpage. This can be done in a variety of ways, including by the user's inserting an additional block of HTML code in the page after it has been downloaded to a browser, or by downloading a plug-in module to modify the behavior of the browser, or by the Web page owner incorporating that code into the page as it resides on the Web server.

In this invention, two control elements are presented to the user: One control element allows the user to choose to change the behavior of hyperlinks; and a second control element allows the user to send the URL list to the masterpage engine to create and display the masterpage. These two switches could be combined into a single switch that changes its characteristics based on context. However, for the purpose of clarity in this description, it shall be assumed that separate switches are provided for each switch function.

The change in the hyperlinks' behavior is effected by so called “onClick” Javascript commands embedded inside the HTML code of the Web page. These commands allow the definition of alternative actions to be triggered when a link is clicked on. For the purpose of this invention, the OnClick command is used to cause a hyperlink's URL to be added to a URL list contained inside the computer memory (specifically, inside a Javascript variable). However, one could achieve the same alteration of the hyperlink's behavior without using Javascript OnClick commands by modifying the browser's client-side software code, for instance through a downloadable plug-in. By virtue of the same plug-in or similar software download, the above-described switches for toggling the link behavior and for displaying the masterpage could be located in the browser's control bar or in any other area of the computer's display area.

The embodiments of the invention described herein are implemented as logical operations in a computer system. The logical operations of the present invention are carried out (1) as a sequence of computer-implemented steps performed on a server system interacting with a client system; or (2) as a sequence of computer-implemented steps performed on a client system only. The implementation is a matter of choice depending on performance requirements.

In one embodiment, the software implementing the invention is completely contained on the Web server. This configuration has the utility that the user can use any currently available browser to access the implementation of the invention without having to install a computer program or other additions to the user's local machine (“client machine”). However, the process of building URL lists for further display inside a single continuously scrollable masterpage may also be achieved by installing additional software on a client machine, for instance using a “browser plug-in” that enhances the capability of currently available browsers.

### OBJECTS OF THE INVENTION

It is an object of this invention to provide a user with a faster way of navigating Web pages that contain multiple links. It is also an object of this invention to offer a user a control element (a link or a button) that allows the user to change the functionality of links on a Web page from their normal mode of operation to a mode that adds the URL of the associated Web page to a URL list contained in the computer's memory. It is a further object of this invention to provide the user with a second control element that, when applied, will pass the URL list to the masterpage engine to cause the display of a masterpage containing all the pages associated with the URLs inside the URL list.

These and other features, utilities and advantages of the invention will be explained in more detail in the following, more specific description of the preferred embodiments of the invention as, illustrated in the accompanying drawings.

### BRIEF DESCRIPTION OF THE DRAWINGS

The objects of the present invention can be found in the detailed description of the preferred embodiment when taken in conjunction with the accompanying drawings, illustrating the invention by way of example and not limitation, with like references indicating similar elements.

FIG. 1 illustrates the process flow of the present invention.

FIG. 2 illustrates the decision process for the present invention.

FIGS. 3a and 3b contrasts the flow of navigating hyperlinks on a standard Web page with the flow of navigating hyperlinks on a Web page using the method of this invention.

### DETAILED DESCRIPTION OF THE DRAWINGS

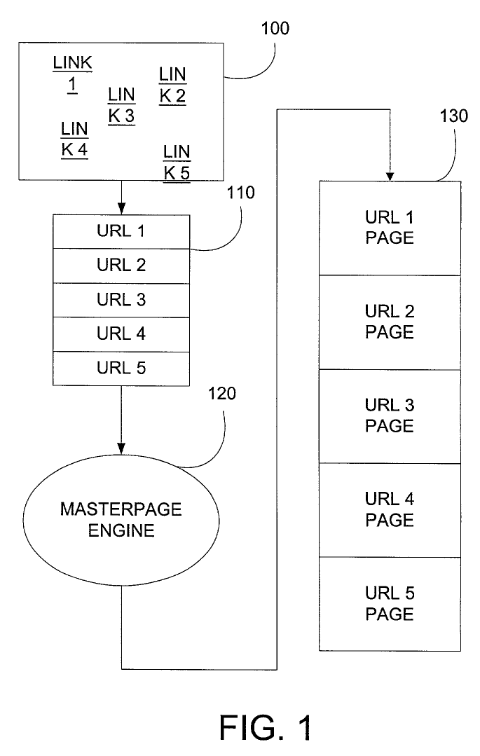

FIG. 1 illustrates the concept of the present invention by showing the components of a Web page that has multiple hyperlink selection installed. In FIG. 1, a Web page having five hyperlinks is displayed 100. Clicking on any of the links causes the URLs associated with each clicked-on link to be added to a URL list 110 contained in the client computer memory. After the desired links have been selected, the display button is clicked, causing the URL list 110 to be passed to the masterpage engine 120. After retrieving the pages to be displayed the masterpage engine will display the pages associated with the URLs in the URL list as a single, continuously scrollable page 130, containing the combined individual pages referenced in the URL list 110.

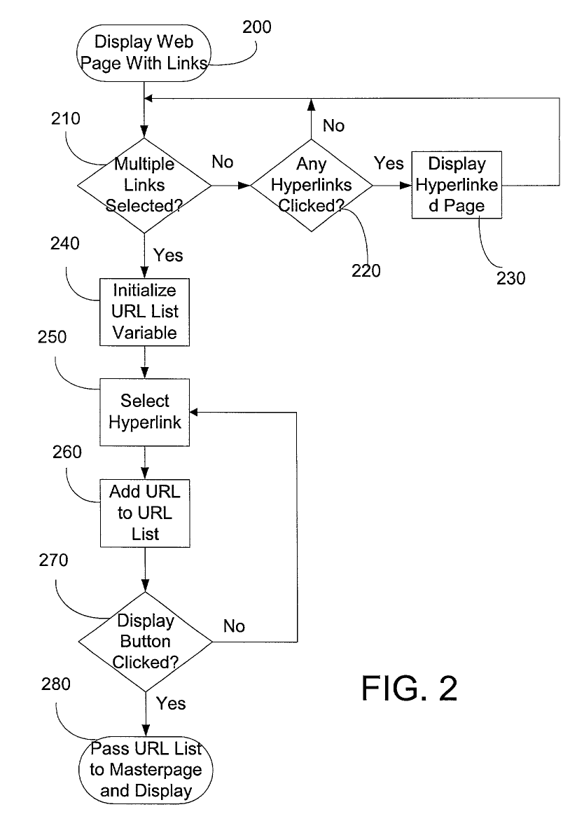

FIG. 2 illustrates the decision process for the method of this invention. Step 200 displays a Web page having multiple links. Step 210 checks to see whether multiple links mode has been selected. If it has not, normal hyperlink processing will occur. When a link is clicked 220, the page associated with the link will be displayed 230, and the process may thereafter be repeated.

If multiple link mode has been selected 210, then the URL list contained in the computer memory will be initialized 240, i.e., if any URLs are remain in the list from the last list created, they will be deleted. When a hyperlink is clicked-on 250, the URL associated with the clicked-on link will be added to the URL list contained inside the computer's memory 260. If the display button is not activated at that time 270, additional links may be selected 250. However, if the next event is to click the display button, 270, then the URL list is passed to the masterpage engine for collection of multiple pages and display of the pages as a masterpage 280. Where the masterpage itself contains multiple links, the process may again be initiated with the display of the masterpage commencing the sequence at 200.

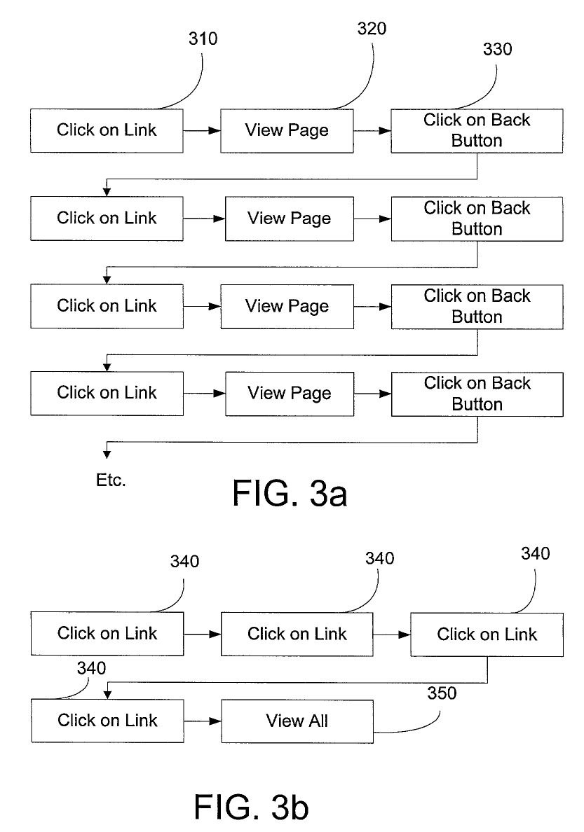

FIG. 3a illustrates the steps a user must take to view multiple Web pages by conventional means. At 310, a user clicks on a hyperlink. After the page at the URL downloads, the user may view it 320. Once viewing is complete, the user must click the “back” button of his or her browser 330 to return to the original page to select another link for viewing. In the event that a user wishes to re-visit any particular link, he or she may repeatedly click the “back” browser button until the correct page is shown, or must again click the link and await the redisplay of the page. These steps may be contrasted with FIG. 3b, which illustrates the steps a user must take in accordance with the present invention. After clicking all links he or she wishes to be displayed 340, the user simply clicks the display button 350 and can then scroll through the display to view all pages from selected hyperlinks. If the user wishes to re-view one of the selected links, he or she need only scroll the masterpage until it is located.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. In a general purpose computer having a processor, a memory, a visual display, and a communications link to the internet, a method of displaying web pages associated with uniform resource locators embedded in hyperlinks in a first web page as panels in a single, continuous, scrollable second web page by modifying the html instructions of said first web page, comprising the steps of:
displaying a first web page by downloading from the internet data and preexisting html instructions for displaying said data as a first web page;
adding html instructions to said preexisting html instructions for said first web page to cause said display to present a user selectable choice between unmodified hyperlink behavior and modified hyperlink behavior such that, if unmodified hyperlink behavior is selected, the behavior of hyperlinks contained in said first web page is unmodified, and if modified hyperlink behavior is selected, then upon the selection of one or more hyperlinks on said first web page, the uniform resource locator embedded in each of said one or more hyperlinks will be placed within a list of uniform resource locators maintained in said memory such that, when hyperlink selection is complete, said list of uniform resource locators will be read from said memory and processed to create said second web page in which the content of each web page associated with each said uniform resource locator is included as a panel in said single, continuous, scrollable second web page.

2. A machine readable storage, having stored thereon a first computer program and a second computer program, each said computer program having a plurality of code sections executable by a machine for causing the machine to perform the steps of:
interfacing said first computer program with said second computer program as said first and second computer programs are being executed by said machine, said second computer program causing said machine to display a first web page consisting of data and html instructions downloaded from a server attached to the internet, said first web page including one or more hyperlinks, each of said one or more hyperlink having embedded within it a uniform resource locator linked to a web page;
said first computer program modifying said second computer program to cause said machine to present a user selectable choice between hyperlink behavior as provided in said second computer program and modified hyperlink behavior as provided in said first computer program such that, if unmodified hyperlink behavior is selected, the behavior of hyperlinks contained in said first web page is as provided in said second computer program without modification, and if modified hyperlink behavior is selected, then upon the selection of one or more hyperlinks on said first web page, the uniform resource locator embedded in each of said one or more hyperlinks will be placed within a list of uniform resource locators maintained in said machine such that, when hyperlink selection is complete, said list of uniform resource locators will be processed by said machine to create a second web page in which the content of each web page associated with each said uniform resource locator is included as a panel in said single, continuous, scrollable second web page.

3. A machine readable storage, having stored thereon data and html instructions for downloading to a user's computer attached to the internet, said data and html instructions comprising a first web page, said first web page containing one or more hyperlinks, each of said one or more hyperlinks having embedded within it a uniform resource locator associated with a web page, said html instructions causing said user's computer to perform the steps of:
displaying said first web page on said user's computer;
presenting a user selectable choice between hyperlink behavior wherein a first choice will cause hyperlink behavior such that any hyperlink selected will immediately download and display a web page associated with the uniform resource locator embedded within said hyperlink;
and a second choice will cause hyperlink behavior such that, upon the selection of one or more hyperlinks on said first web page, the uniform resource locator embedded in each of said one or more hyperlinks will be placed within a list of uniform resource locators such that, when hyperlink selection is complete, said list of uniform resource locators will be processed to create a second web page in which the content of each web page associated with each said uniform resource locator is included as a panel in a single, continuous, scrollable second web page.
